(19) United States
(12) Patent Application Publication
(10) Pub. No.: US 2008/0053327 A1
(43) Pub. Date: Mar. 6, 2008

(54) IDENTIFYING SHEETS WITHIN STACKS USING EDGE MARKING

(76) Inventor: Richard L. Weilacher, Webster, NY (US)

Correspondence Address: Frederick W. Gibb, III;Gibb I.P. Law Firm, LLC, Suite 304, 2568-A Riva Road, Annapolis, MD, 21401, US

(21) Appl. No.: 11/469,516

(22) Filed: Sep. 1, 2006

(51) Int. Cl. B41F 33/00

(52) U.S. Cl. 101/484

(57) ABSTRACT

Embodiments herein include a method of identifying sheets within a stack of printed sheets for sorting or further evaluation. In one embodiment the method comprises printing non-test production printing job(s) on sheets of media and outputting the printed sheets into a stack of sheets. The method monitors the printing of the non-test production printing jobs and, upon the occurrence of a “predetermined event” during the monitoring, adds a unique marking at an edge region of a printed sheet (of the non-test production printing jobs) being printed to create an identifier sheet from one of the sheets of the non-test production printing jobs. The unique marking is visible from the side of the stack of sheets. The identifier sheet is then output to the stack of sheets with the other sheets of the non-test production print job. During the remainder of the printing of the non-test production print job the method continues the printing of the sheets and the monitoring. After the printing is completed, the identifier sheet can be subjected to specific inspection or can be used to indicate a specific sheet count within the stack of sheets. Then the stack of sheets can be subjected to subsequent processing such as trimming and binding, wherein the trimming process removes the edge region from the printed sheets.

### BACKGROUND

Embodiments herein generally relate to electrostatographic printers and copiers or reproduction machines, and more particularly, concerns a method of identifying sheets within a stack of printed sheets for sorting or further evaluation.

In a typical electrophotographic printing process, a photoconductive member is charged to a substantially uniform potential so as to sensitize the surface thereof. The charged portion of the photoconductive member is exposed to a light image of an original document being reproduced. Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith. Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated or fused to permanently affix the powder image to the copy sheet.

The foregoing generally describes a typical black and white electrophotographic printing machine. With the advent of multicolor electrophotography, it is desirable to use an architecture which comprises a plurality of image forming stations. One example of the plural image forming station architecture utilizes an image-on-image (IOI) system in which the photoreceptive member is recharged, reimaged and developed for each color separation. This charging, imaging, developing and recharging, reimaging and developing, all followed by transfer to paper, is done in a single revolution of the photoreceptor in so-called single pass machines, while multipass architectures form each color separation with a single charge, image and develop, with separate transfer operations for each color.

In addition, as described in U.S. Pat. No. 6,385,405, the complete disclosure of which is incorporated herein by reference, direct marking technologies, and in particular ink jet printing, have emerged as printing alternatives that incorporate relatively simpler hardware requirements. However, images produced with the inks used in ink jet marking technologies, and particularly in thermal ink jet marking technologies, do not always exhibit the same high level of clarity or permanence as xerographically produced images. Therefore, as described in U.S. Pat. No. 6,385,405, ink jet printing can be combined with electrophotographic printing to fuse the ink onto the page.

In direct marking technologies, ink in the desired image is applied directly to the print medium. Various techniques of direct marking are well understood in the art. For example, the image may be applied by direct contact between a pen and the medium. Alternatively, ink jet recording techniques eject droplets of ink from a printhead onto the medium. Such ink jet techniques may include thermal ink jets, acoustic ink jet, piezo-electric ink jet printing, and others. Ink jet recording devices eject ink onto a print medium such as paper in controlled patterns of closely spaced dots. To form color images, multiple groupings of ink jets are used, with each group being supplied with ink of a different color from an associated ink container.

When performing the fusing of the image onto the sheet, a fuser typically fixes the toner layer with the embedded image onto the surface of the print medium. The fuser may be of the type conventionally used with xerographic printers. For example, the fuser may include a fuser roller and a pressure roller. The fuser roller may be heated to melt the toner, while the pressure roller presses the print medium against the fuser roller. The fuser roller may also be unheated. Those familiar with the xerographic printing arts will recognize that radiant fusing may also be used. Radiant fusing systems use intense light, such as a quartz rod to melt the toner and fuse it with the fibers of the paper. Those skilled in the art will also recognize that other fusing mechanisms used in the xerographic printing art may also be used for the fuser of the embodiment illustrated.

### SUMMARY

Embodiments herein include a method of identifying sheets within a stack of printed sheets for sorting or further evaluation. In one embodiment, the method comprises printing non-test production printing job(s) on sheets of media and outputting the printed sheets into a stack of sheets. The method monitors the printing of the non-test production printing jobs and, upon the occurrence of a “predetermined event” during the monitoring, adds a unique marking at an edge region of a printed sheet (of the non-test production printing jobs) being printed to create an identifier sheet from one of the sheets of the non-test production printing jobs. The unique marking is visible from the side of the stack of sheets. The identifier sheet is then output to the stack of sheets with the other sheets of the non-test production print job. During the remainder of the printing of the non-test production print job, the method continues the printing of the sheets and the monitoring. After the printing is completed, the identifier sheet can be subjected to specific inspection or can be used to indicate a specific sheet count within the stack of sheets. Then, the stack of sheets can be subjected to subsequent processing such as trimming and binding, wherein the trimming process removes the edge region from the printed sheets.

The “monitoring” process mentioned above can comprise many different activities from quality monitoring to sheet number counting. Thus, in one embodiment, the “monitoring” process comprises counting the number of printed sheets and the “event” comprises a predetermined number of sheets being printed from the start of the printing process or from the printing of the most recent identifier sheet. Similarly, the monitoring can comprise observing the image quality of the printed sheets and the “event” can comprise the image quality being outside of a predetermined normal range. Also, the monitoring can comprise monitoring parameters of a printer performing the printing and the “event” can comprise a parameter being out of a predetermined normal range. Further, not all potentially defective sheets need be marked and embodiments herein can simply identify a range of potentially mis-printed sheets by a beginning identifier sheet having the unique marking at an edge of the beginning identifier sheet when a parameter goes outside of the normal range and printing an ending identifier sheet having the unique marking at an edge of the ending identifier sheet when a parameter returns to within the normal range.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow chart illustrating a method of edge-marking sheets;

FIG. 2 is a schematic diagram of an edge-marked sheet;

FIG. 3 is a schematic diagram of a sheet stack containing edge-marked sheets; and

FIG. 4 is a schematic diagram of an electrostatic printing machine.

### DETAILED DESCRIPTION

The embodiments herein are useful with printing/copying devices such as those discussed in U.S. Patent Application 2003/0039491, the complete disclosure of which is incorporated herein by reference, and portions of which are incorporated herein.

This invention relates to a printing system which is used to produce color output in a single pass of a photoreceptor belt. It will be understood, however, that it is not intended to limit the invention to the embodiment disclosed. On the contrary, it is intended to cover all alternatives, modifications and equivalents as may be included within the spirit and scope of the invention as defined by the appended claims, including a multi-pass color process system, a single or multiple pass highlight color system and a black and white printing system.

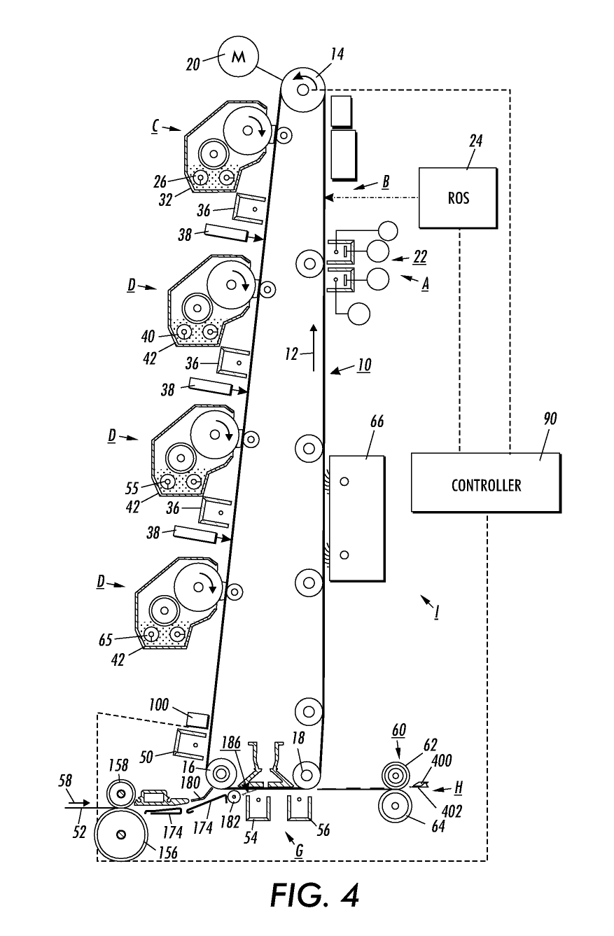

Turning now to FIG. 4, an electrophotographic printing machine uses a charge retentive surface in the form of an Active Matrix (AMAT) photoreceptor belt 10 supported for movement in the direction indicated by arrow 12, for advancing sequentially through the various xerographic process stations. The belt is entrained about a drive roller 14 and tension and steering rollers 16 and 18 respectively, roller 14 is operatively connected to a drive motor 20 for effecting movement of the belt through the xerographic stations.

With continued reference to FIG. 4, a portion of belt 10 passes through charging station A where a corona generating device, indicated generally by the reference numeral 22, charges the photoconductive surface of belt 10 to a relative high, substantially uniform, preferably negative potential.

Next, the charged portion of photoconductive surface is advanced through an imaging station B. At exposure station B, the uniformly charged belt 10 is exposed to a laser based output scanning device 24 which causes the charge retentive surface to be discharged in accordance with the output from the scanning device. The scanning device can be a laser Raster Output Scanner (ROS). Alternatively, the ROS could be replaced by other xerographic exposure devices such as LED arrays.

The photoreceptor, which is initially charged to a voltage V_{c} undergoes dark decay to a level V_{ddp} equal to about −500 volts. When exposed at the exposure station B it is discharged to V_{image} equal to about −50 volts. Thus after exposure, the photoreceptor contains a monopolar voltage profile of high and low voltages, the former corresponding to charged areas and the latter corresponding to discharged or image areas.

At a first development station C, developer structure, indicated generally by the reference numeral 32 utilizing a hybrid jumping development (HJD) system, the development roll, better known as the donor roll, is powered by two development fields (potentials across an air gap). The first field is the AC jumping field which is used for toner cloud generation. The second field is the DC development field which is used to control the amount of developed toner mass on the photoreceptor. The toner cloud causes charged toner particles 26 to be attracted to the electrostatic latent image. Appropriate developer biasing is accomplished via a power supply. This type of system is a noncontact type in which only toner particles (magenta, for example) are attracted to the latent image and there is no mechanical contact between the photoreceptor and a toner delivery device to disturb a previously developed, but unfixed, image.

The developed but unfixed image is then transported past a second charging device 36 where the photoreceptor and previously developed toner image areas are recharged to a predetermined level.

A second exposure/imaging is performed by imaging device 38 which comprises a laser based output structure and is utilized for selectively discharging the photoreceptor on toned areas and/or bare areas, pursuant to the image to be developed with the second color toner. At this point, the photoreceptor contains toned and untoned areas at relatively high voltage levels and toned and untoned areas at relatively low voltage levels. These low voltage areas represent image areas which are developed using discharged area development (DAD). To this end, a negatively charged, developer material 40 comprising color toner is employed. The toner, which by way of example may be yellow, is contained in a developer housing structure 42 disposed at a second developer station D and is presented to the latent images on the photoreceptor by way of a second HSD developer system. A power supply serves to electrically bias the developer structure to a level effective to develop the discharged image areas with negatively charged yellow toner particles 40.

The above procedure is repeated for a third image for a third suitable color toner such as cyan, and for a fourth image and suitable color toner such as black. The exposure control scheme described below may be utilized for these subsequent imaging steps. In this manner a full color composite toner image is developed on the photoreceptor belt.

To the extent to which some toner charge is totally neutralized, or the polarity reversed, thereby causing the composite image developed on the photoreceptor to consist of both positive and negative toner, a negative pre-transfer dicorotron member 50 is provided to condition the toner for effective transfer to a substrate using positive corona discharge.

Subsequent to image development, a sheet of support material 52 is moved into contact with the toner images at transfer station G. The sheet of support material is advanced to transfer station G by a sheet feeding apparatus to the pretransfer device which directs the advancing sheet of support material into contact with photoconductive surface of belt 10 in a timed sequence so that the toner powder image developed thereon contacts the advancing sheet of support material at transfer station G.

Transfer station G includes a transfer dicorotron 54 which sprays positive ions onto the backside of sheet 52. This attracts the negatively charged toner powder images from the belt 10 to sheet 52. A detack dicorotron 56 is provided for facilitating stripping of the sheets from the belt 10.

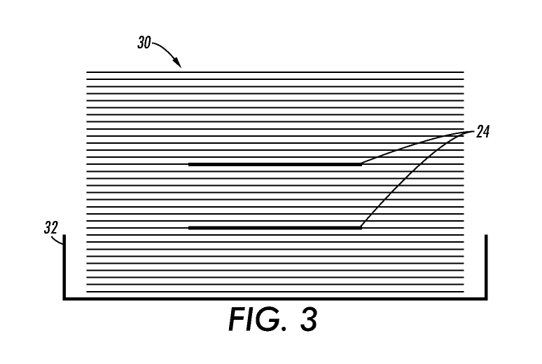

After transfer, the sheet continues to move, in the direction of arrow 58, onto a conveyor which advances the sheet to fusing station H. Fusing station H includes a fuser assembly, indicated generally by the reference numeral 60, which permanently affixes the transferred powder image to sheet 52. The fuser assembly 60 comprises a heated fuser roller 62 and a backup or pressure roller 64. Sheet 52 passes between fuser roller 62 and backup roller 64 with the toner powder image contacting fuser roller 62. In this manner, the toner powder images are permanently affixed to sheet 52 after it is allowed to cool. After fusing, the sheet is separated from the fuser roll by the corrugating air knife, to a chute, not shown, which guides the advancing sheets 52 to a catch tray 32 (shown in FIG. 3) for subsequent removal from the printing machine by the operator.

After the sheet of support material is separated from photoconductive surface of belt 10, the residual toner particles carried by the non-image areas on the photoconductive surface are removed therefrom. These particles are removed at cleaning station I using a cleaning brush structure contained in a housing 66.

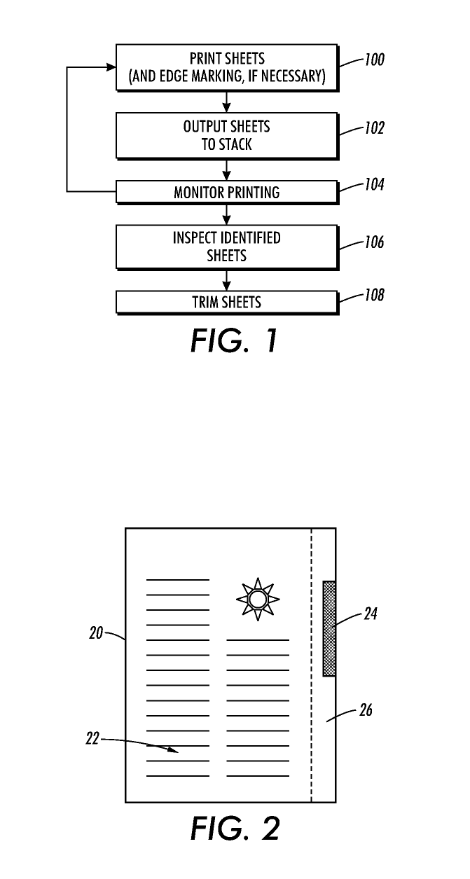

Referring now to FIG. 1, a method of identifying certain sheets within a stack of printed sheets (for, counting, sorting, or further evaluation/inspection) is shown in flowchart form. In one embodiment, the method comprises printing non-test production printing job(s) on sheets of media (item 100) and outputting the printed sheets into a stack of sheets (item 102). The method monitors the printing of the non-test production printing jobs in item 104 and, upon the occurrence of a “predetermined event” during the monitoring, causes the printing in item 100 to add a unique marking at an edge region of the next printed sheet (of the non-test production printing jobs) being printed to create an identifier sheet from one of the sheets of the non-test production printing jobs. The identifier sheet is then output to the stack of sheets with the other sheets of the non-test production print job in item 102.

During the remainder of the printing of the non-test production print job, the method continues the printing of the sheets and the monitoring as shown by the arrow running from item 104 to item 100. After the printing is completed, the identifier sheet can be subjected to specific inspection or can be used to indicate a specific sheet count within the stack of sheets as shown by item 106. Then, the stack of sheets can be subjected to subsequent processing such as trimming and binding, wherein the trimming process removes the edge region from the printed sheets as shown by item 108.

During the remainder of the printing of the non-test production print job, the method continues the printing of the sheets and the monitoring as shown by the arrow running from item 104 to item 100. After the printing is completed, the identifier sheet can be subjected to specific inspection by the user or technician can be used to indicate a specific sheet count within the stack of sheets as shown by item 110. Then, the stack of sheets can be subjected to subsequent processing such as trimming and binding, wherein the trimming process removes the edge region from the printed sheets as shown by item 108.

The embodiments herein print the edge markings on actual sheets used in actual production jobs as opposed to test jobs or test sheets. Thus, the embodiments herein allow continuous printing, even when machine parameters or printing quality may be outside normal ranges. In other words, the embodiments herein are different than those systems that involve the printing of testing or calibration sheets because the embodiments herein print the edge markings on actual production sheets of production runs made for customers. It is intended that all production runs should be printed error-free; however, because of various imperfections, occasionally errors occur during the printing of the production runs, and it is at this point in the process that some embodiments herein come into play. This situation is to be distinguished from set-up or testing situations where the output from the printing device will not be provided to the customer and, instead where the output is used merely to test and set up the printer. Therefore, the term production printing job comprises a printing operation that produces output intended to be provided to the customer (publisher, end user, public, etc.) as contrasted with output used to setup or test the printer itself.

The “monitoring” process in item 104 can comprise many different activities from quality monitoring to sheet number counting. Thus, in one embodiment, the “monitoring” process 104 comprises counting the number of printed sheets and the “event” comprises a predetermined number of sheets being printed from the start of the printing process or from the printing of the most recent identifier sheet. For example, an identifier sheet having the edge marking can be output at every 50th sheet, every 100th sheet, every 200th sheet, etc., or can be output at the end of every job or sub-job. Thus, embodiments herein can add the edge marking to any printing sheet being printed to create an identifier sheet whenever necessary to alert the printer technician of different items or amounts that are within the output stack of sheets.

Similarly, the monitoring 104 can comprise observing the image quality of the printed sheets and the “event” can comprise the image quality being outside of a predetermined normal range. Also, the monitoring 104 can comprise monitoring parameters of a printer performing the printing (e.g., ink or toner levels, temperatures, sensors, etc.) and the “event” can comprise a parameter being out of a predetermined normal range. The image quality and the parameters of the printer can be monitored automatically and/or manually. Therefore, embodiments herein allow the printer itself to automatically produce identifier sheets whenever preset parameters are exceeded, and also allow the printer technician to manually add edge markings to the sheets being printed to create identifier sheets that are then sent to the output to the stack. Note, that there may be a slight delay (of one or more sheets) before the edge marking may be added because the quality monitoring is performed on sheets that have already been printed and the edge marking is added to sheets that are being printed after the quality defect is detected. Therefore, the technician must inspect not only the sheets to which the edge marking has been added, but also a few sheets ahead of the one or ones to which the markings were added.

FIG. 2 illustrates a non-test production print job sheet 20 that has been printed with data, graphics, and text 22. In addition, this sheet 20 has received the edge marking 24 (unique marking) and therefore comprises an identifier sheet. Further, the edge marking 24 is printed only within the trim region 26 which will be removed from the sheet 20 during the subsequent trimming process (item 112 in FIG. 1).

One feature of embodiments herein is that the unique edge marking 24 is visible from the side of the stack of sheets. While the edge marking 24 is printed using the same printing engines that print the data, graphics, and text 22 (and therefore prints on the front or back side of the media sheet) the edge marking 24 is printed all the way to the edge (and sometimes past the edge) of the sheet 20, which allows the edge marking 24 to be visible from the edge of the sheet. Therefore, the edge marking is visible from the edge of the sheet when the edge marked identifier sheet is included within a stack of sheets 30, as shown in FIG. 3, which makes the edge marking 24 visible from the side of the stack of sheets. By printing the edge marking 24 all the way to the edge, some of the printing agent (ink, toner, etc.) can be adsorbed by the actual edge of the sheet, making the edge marking 24 even more visible from the edge of a stack of sheets.

For purposes of this application the print media sheet (which can comprise paper, transparencies, card stock, plastic transfers, polymers, or any other substance capable of being printed upon) is generally flat and includes a front side and a back side with a top edge, bottom edge and two side edges. The edge marking 24 is printed on the front and/or back side where one of the sides meets one or more of the top, bottom, or side edges. Similarly, for purposes of this application, the stack of sheets will have a top where the front or back side of the top sheet appears, a bottom opposite the top, and four sides where the top, bottom, and side edges of the sheets are visible.

Further, not all potentially defective sheets need be marked and embodiments herein can simply identify a range of potentially incorrectly printed sheets using a beginning identifier sheet having the edge marking that is output when a parameter goes outside of the normal range and using an ending identifier sheet having the edge marking when a parameter returns to within the normal range. Thus, for example, as shown in FIG. 3 two edge markings 24 have been printed on two different sheets within a stack 30 of non-test production printed sheets. While one embodiment herein marks every sheet for which an “event” (as defined above) has occurred, other embodiments can mark only the beginning and ending of the event, with the sheets between the beginning identifier sheet and the ending identifier sheets not being marked. Thus, the edge markings 24 shown in FIG. 3 could comprise two individual separate events or could comprise a beginning identifier sheet and an ending identifier sheet.

Further, the beginning identifier sheet could have an edge marking that is a different color than the edge marking of the ending identifier sheet. In addition, different colored edge markings can be used to indicate different types of errors or different types of counts, and item 24 in FIGS. 2 and 3 is intended to represent colored edge markings. Also, to aid the technician in locating the identifier sheet, a group of consecutive sheets having the same edge marking can be printed and output to the stack of sheets so that the edge marking appears more prominently within the stack of sheets. Such groups can comprise groups of 5 sheets, 10 sheets, 15 sheets, or any other number of sheets that is determined to aid in the appearance of the edge marking when the stack of sheets is viewed from the side.

The embodiments herein allow continuous printing, even when machine parameters or printing quality may be outside normal ranges. This allows the printer to remain running at full capacity even during temporary periods when the print quality may be degraded. By marking the potentially improperly printed sheets with edge markings, the technician operating the printer can be easily directed to the sheets which need to be inspected for possible reprinting. While embodiments herein may require some sheets to be reprinted, by maintaining a printer at full capacity, overall productivity increases.

The word “printer” or “image output terminal” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the invention should not be implied or imported from any above example as limitations to any particular order, number, position, size, shape, angle, color, or material.

What is claimed is:

1. A method comprising:
printing on sheets of media;
outputting printed sheets from said printing into a stack of sheets;
monitoring said printing;
upon the occurrence of a predetermined event during said monitoring, adding a unique marking at an edge of a sheet being printed to create an identifier sheet, such that said unique marking is visible from a side of said stack of sheets;
outputting said identifier sheet to said stack of sheets; and
continuing said printing of said sheets and said monitoring.

2. The method according to claim 1, wherein said monitoring comprises counting a number of said printed sheets and said event comprises a predetermined number of sheets being printed from a start of said printing process or a predetermined number of sheets being printed from a printing of a most recent identifier sheet.

3. The method according to claim 1, wherein said monitoring comprises observing a image quality of said printed sheets and said event comprises said image quality being out of a predetermined normal range.

4. The method according to claim 1, wherein said monitoring comprises monitoring parameters of a printer performing said printing and said event comprises a parameter being out of a predetermined normal range.

5. The method according to claim 4, further comprising printing a beginning identifier sheet having said unique marking at an edge of said beginning identifier sheet when a parameter goes outside of said normal range and printing an ending identifier sheet having said unique marking at an edge of said ending identifier sheet when a parameter returns to within said normal range.

6. A method comprising:
printing on sheets of media;
outputting printed sheets from said printing into a stack of sheets;
monitoring said printing;
upon the occurrence of a predetermined event during said monitoring, adding a unique marking at an edge region of a sheet being printed to create an identifier sheet, such that said unique marking is visible from a side of said stack of sheets;
outputting said identifier sheet to said stack of sheets;
continuing said printing of said sheets and said monitoring; and
trimming said stack of sheets, wherein said trimming process removes said edge region from said printed sheets.

7. The method according to claim 6, wherein said monitoring comprises counting a number of said printed sheets and said event comprises a predetermined number of sheets being printed from a start of said printing process or a predetermined number of sheets being printed from a printing of a most recent identifier sheet.

8. The method according to claim 6, wherein said monitoring comprises observing a image quality of said printed sheets and said event comprises said image quality being out of a predetermined normal range.

9. The method according to claim 6, wherein said monitoring comprises monitoring parameters of a printer performing said printing and said event comprises a parameter being out of a predetermined normal range.

10. The method according to claim 9, further comprising printing a beginning identifier sheet having said unique marking at an edge of said beginning identifier sheet when a parameter goes outside of said normal range and printing an ending identifier sheet having said unique marking at an edge of said ending identifier sheet when a parameter returns to within said normal range.

11. A method comprising:
printing at least one non-test production printing job on sheets of media;
outputting printed sheets from said printing into a stack of sheets;
monitoring said printing of said non-test production printing job;
upon the occurrence of a predetermined event during said monitoring, adding a unique marking at an edge region of a printed sheet of said non-test production printing job being printed to create an identifier sheet from a sheet of said non-test production printing job, such that said unique marking is visible from a side of said stack of sheets;
outputting said identifier sheet to said stack of sheets;
continuing said printing of said sheets and said monitoring;
subjecting said identifier sheet to inspection; and
trimming said stack of sheets, wherein said trimming process removes said edge region from said printed sheets.

12. The method according to claim 11, wherein said monitoring comprises counting a number of said printed sheets and said event comprises a predetermined number of sheets being printed from a start of said printing process or a predetermined number of sheets being printed from a printing of a most recent identifier sheet.

13. The method according to claim 11, wherein said monitoring comprises observing a image quality of said printed sheets and said event comprises said image quality being out of a predetermined normal range.

14. The method according to claim 11, wherein said monitoring comprises monitoring parameters of a printer performing said printing and said event comprises a parameter being out of a predetermined normal range.

15. The method according to claim 14, further comprising printing a beginning identifier sheet having said unique marking at an edge of said beginning identifier sheet when a parameter goes outside of said normal range and printing an ending identifier sheet having said unique marking at an edge of said ending identifier sheet when a parameter returns to within said normal range.

16. A computer program product comprising:
a computer-usable data carrier storing instructions that, when executed by a computer, cause the computer to perform a method comprising:
printing on sheets of media;
outputting printed sheets from said printing into a stack of sheets;
monitoring said printing;
upon the occurrence of a predetermined event during said monitoring, adding a unique marking at an edge of a sheet being printed to create an identifier sheet, such that said unique marking is visible from a side of said stack of sheets;
outputting said identifier sheet to said stack of sheets; and
continuing said printing of said sheets and said monitoring.

17. The computer program product according to claim 16, wherein said monitoring comprises counting a number of said printed sheets and said event comprises a predetermined number of sheets being printed from a start of said printing process or a predetermined number of sheets being printed from a printing of a most recent identifier sheet.

18. The computer program product according to claim 16, wherein said monitoring comprises observing a image quality of said printed sheets and said event comprises said image quality being out of a predetermined normal range.

19. The computer program product according to claim 16, wherein said monitoring comprises monitoring parameters of a printer performing said printing and said event comprises a parameter being out of a predetermined normal range.

20. The computer program product according to claim 19, further comprising printing a beginning identifier sheet having said unique marking at an edge of said beginning identifier sheet when a parameter goes outside of said normal range and printing an ending identifier sheet having said unique marking at an edge of said ending identifier sheet when a parameter returns to within said normal range.
